(19) United States
(12) Patent Application Publication
(10) Pub. No.: US 2026/0296498 A1
(43) Pub. Date: Oct. 1, 2026

(54) AUTONOMOUS VEHICLE ROUTE PLANNING

(71) Applicant: Ford Global Technologies, LLC, Dearborn, MI (US)

(72) Inventor: Keith Weston, Canton, MI (US)

(21) Appl. No.: 19/093,110

(22) Filed: Mar. 27, 2025

(51) Int. Cl. B60W 60/00; G01C 21/34; G01C 21/36; G07C 5/04

(52) U.S. Cl. CPC B60W 60/00256; B60W 60/005; G01C 21/3461; G01C 21/3469; G01C 21/3691; G07C 5/04; B60W 2555/20; B60W 2556/45

(57) ABSTRACT

Operating vehicles in coordination with a commercial driver license (CDL) driver includes receiving route parameters including a destination and a current vehicle location; sending a route query based on the route parameters to an operational design domain (ODD) server to receive ODD information defining autonomous operation conditions and boundaries; sending the route query to a weather server to receive current and predicted weather information; determining, based on the received ODD information, the weather information, and an activity log documenting allowable commercial driver operation time under CDL rules, a route optimized to maximize autonomous driving segments and manage commercial driver rest periods; and operating the vehicle along the route using an autonomous driving subsystem within ODD zones conformant with the ODD information, and under CDL driver control outside the ODD zones.

### TECHNICAL FIELD

Aspects of the disclosure relate to optimizing the efficiency of a commercial driver license (CDL) driver using a Society of Automotive Engineer (SAE) Level 4 autonomous vehicle, by leveraging the vehicle's autonomy within defined operational design domains (ODDs).

### BACKGROUND

ODDs may be used to define operating conditions within which the autonomous driving systems of a vehicle may be engaged. ODDs may be defined for categories such as physical infrastructure, operational constraints, objects, connectivity, environmental conditions, and driving zones.

A CDL driver may be subject to time limits for when the driver is allowed to drive, how long of a shift that the driver is allowed to drive, and when and how long of break the driver is required to take. In some cases, the driver may also be limited to a maximum overall driving hours within a week or eight day timeframe.

### SUMMARY

In one or more illustrative examples, a method of operating an autonomous vehicle in coordination with a commercial driver license (CDL) driver includes receiving route parameters including a destination and a current vehicle location; sending a route query based on the route parameters to an operational design domain (ODD) server to receive ODD information defining autonomous operation conditions and boundaries; sending the route query to a weather server to receive current and predicted weather information; determining, based on the received ODD information, the weather information, and an activity log documenting allowable commercial driver operation time under commercial driver license (CDL) rules, a route optimized to maximize autonomous driving segments and manage commercial driver rest periods; and operating the vehicle along the route using an autonomous driving subsystem within ODD zones conformant with the ODD information, and under CDL driver control outside the ODD zones.

In one or more illustrative examples, the method further includes updating the activity log by automatically recording durations of operation by the autonomous driving subsystem and by the commercial driver.

In one or more illustrative examples, determining the route includes selecting route segments to minimize total driving time of the commercial driver outside the ODD zones.

In one or more illustrative examples, the activity log includes automated recording of timestamps indicating transitions between commercial driver and the autonomous driving subsystem.

In one or more illustrative examples, the route parameters further include one or more intermediate waypoints, the intermediate waypoints including refueling locations, pick up locations, and/or drop-off locations.

In one or more illustrative examples, the autonomous driving subsystem operates, without human intervention, in Society of Automotive Engineer (SAE) Level 4 autonomous operation.

In one or more illustrative examples, the method further includes excluding autonomous use of portions of ODD zones overlapping weather zones indicated by the weather information as being unavailable based on the ODD information.

In one or more illustrative examples, the method further includes determining the route as a using a weighted objective function to minimize a weighting of commercial driver time, total driving distance, and energy usage.

In one or more illustrative examples, an autonomous vehicle for operating autonomously and in coordination with a commercial driver includes an autonomous driving subsystem; a storage maintaining an activity log documenting allowable commercial driver operation time under CDL rules; and one or more computing devices, configured to receive route parameters including a destination and a current vehicle location, send a route query based on the route parameters to an ODD server to receive ODD information defining autonomous operation conditions and boundaries, send the route query to a weather server to receive current and predicted weather information, determine, based on the received ODD information, the weather information, and the activity log, a route optimized to maximize autonomous driving segments and manage commercial driver rest periods, operate the vehicle along the route using the autonomous driving subsystem within ODD zones conformant with the ODD information, and under CDL driver control outside the ODD zones.

In one or more illustrative examples, the one or more computing devices are further configured to one or more of update the activity log by automatically recording durations of operation by the autonomous driving subsystem and by the commercial driver, or wherein the activity log includes automated recording of timestamps indicating transitions between commercial driver and the autonomous driving subsystem.

In one or more illustrative examples, determining the route includes selecting route segments to minimize total driving time of the commercial driver outside the ODD zones.

In one or more illustrative examples, the route parameters further include one or more intermediate waypoints, the intermediate waypoints including refueling locations, pick up locations, and/or drop-off locations.

In one or more illustrative examples, the autonomous driving subsystem operates, without human intervention, in SAE Level 4 autonomous operation.

In one or more illustrative examples, the one or more computing devices are further configured to exclude autonomous use of portions of ODD zones overlapping weather zones indicated by the weather information as being unavailable based on the ODD information.

In one or more illustrative examples, the one or more computing devices are further configured to determine the route as a using a weighted objective function to minimize a weighting of commercial driver time, total driving distance, and energy usage.

In one or more illustrative examples, a non-transitory computer-readable medium includes instructions for operating an autonomous vehicle both autonomously and in coordination with a commercial driver, that when executed by one or more computing devices cause the one or more computing devices to perform operations including to receive route parameters including a destination and a current vehicle location, send a route query based on the route parameters to an ODD server to receive ODD information defining autonomous operation conditions and boundaries, send the route query to a weather server to receive current and predicted weather information, determine, based on the received ODD information, the weather information, and an activity log documenting allowable commercial driver operation time under CDL rules, a route optimized to maximize autonomous driving segments and manage commercial driver rest periods, operate the vehicle along the route using an autonomous driving subsystem of the vehicle within ODD zones conformant with the ODD information, and under CDL driver control outside the ODD zones.

In one or more illustrative examples, the non-transitory computer-readable medium further includes instructions that, when executed by the one or more computing devices, cause the one or more computing devices to perform operations including to update the activity log by automatically recording durations of operation by the autonomous driving subsystem and by the commercial driver, wherein the activity log includes automated recording of timestamps indicating transitions between commercial driver and the autonomous driving subsystem.

In one or more illustrative examples, determining the route includes selecting route segments to minimize total driving time of the commercial driver outside the ODD zones.

In one or more illustrative examples, the non-transitory computer-readable medium further includes instructions that, when executed by the one or more computing devices, cause the one or more computing devices to perform operations including to exclude autonomous use of portions of ODD zones overlapping weather zones indicated by the weather information as being unavailable based on the ODD information.

In one or more illustrative examples, the non-transitory computer-readable medium further includes instructions that, when executed by the one or more computing devices, cause the one or more computing devices to perform operations including to determine the route as a using a weighted objective function to minimize a weighting of commercial driver time, total driving distance, and energy usage.

### BRIEF DESCRIPTION OF THE DRAWINGS

FIG. 1 illustrates an example system for directing vehicles using a combination of CDL driver and autonomous driving;

FIG. 2 illustrates an example process for determining a route to be traversed by the vehicle;

FIG. 3A illustrates an example navigation user interface of the vehicle human machine interface illustrating the ODD zones and additionally weather zones gleaned from the weather information;

FIG. 3B illustrates an example navigation user interface of the vehicle human machine interface illustrating revised ODD zones based on the weather information;

FIG. 3C illustrates an example navigation user interface of the vehicle human machine interface illustrating a revised route path based on the revised ODD zones;

FIG. 4 illustrates an example process for determining and traversing a route by the vehicle; and

FIG. 5 illustrates an example computing device supporting the determining and traversing a route by the vehicle.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

With SAE Level 4 Autonomy, a vehicle can control all aspects of driving within a defined operational design domain (ODD). The ODD might be limited geographically (e.g., a specific highway system) and/or limited by weather conditions. Within the ODD, the driver does not need to be capable of taking over. This level is often found in robotaxis operating in limited areas.

Commercial vehicle drivers are required to take breaks and rest during the work. For example, a CDL driver cannot drive more than eleven hours after being off-duty for ten consecutive hours. In another example, after eight hours of continuous driving, most drivers are required to take a 30-minute break. Significantly, during those break or rest times, the vehicle may be allowed to drive using its SAE Level 4 Autonomy.

Aspects of the disclosure generally relates to leveraging SAE level 4 autonomy to maximize the efficiency of the partnership between a CDL driver and a SAE level 4 autonomous vehicle. By sharing the driving responsibilities, the vehicle may provide longer total driving times while remaining within the overall CDL limits and ODD definitions. The vehicle may also perform recordkeeping to create automated logs to delineate time and information around when the CDL driver is operating the vehicle and precisely when SAE Level 4 Autonomous operation is engaged. This may serve to confirm and/or validate conformance with CDL and ODD rules. Further aspects of the disclosure are discussed in detail herein.

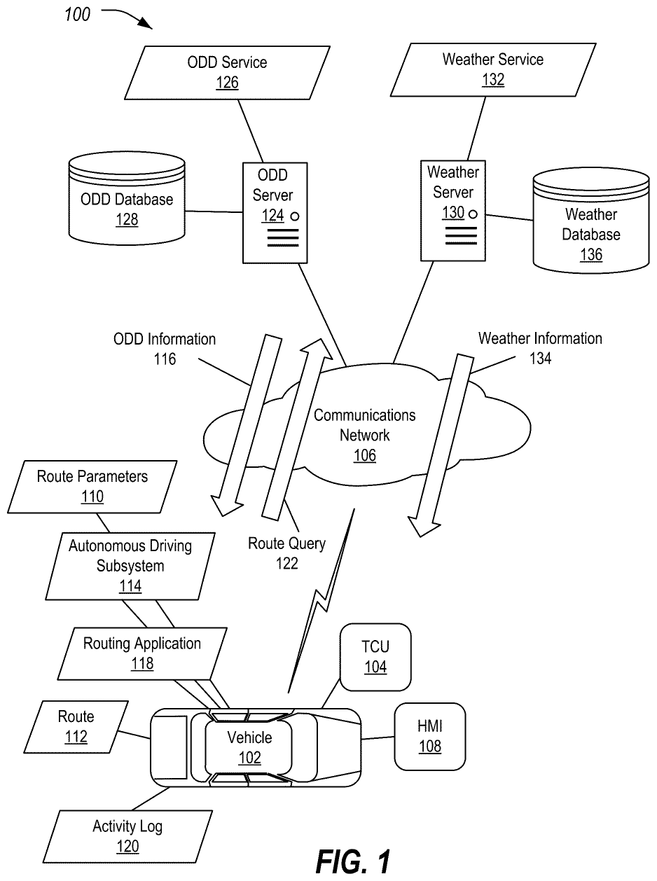

FIG. 1 illustrates an example system 100 for directing vehicles 102 using a combination of CDL driver and autonomous driving. The vehicle 102 may include a telematics control unit (TCU) 104 configured to communicate over a communications network 106. The vehicle 102 may also include a human machine interface (HMI) 108 and may travel along a route 112 created based on route parameters 110. At least a portion of the route 112 may be traversed using an autonomous driving subsystem 114 configured to navigate the vehicle 102 based on ODD information 116. The vehicle 102 may also execute a routing application 118 to maintain an activity log 120 of the operation of the vehicle 102 as well as to generate route queries 122 based on the route parameters 110. An ODD server 124 may be configured to execute an ODD service 126 to receive the route queries 122 and provide relevant ODD information 116 in response using an ODD database 128. A weather server 130 may be configured to execute a weather service 132 to also receive the route queries 122 and to provide relevant weather information 134 in response using a weather database 136. Using the ODD information 116, the weather information 134, and the activity log 120, the routing application 118 may be configured to construct a route 112 that optimizes use of autonomous driving subsystem 114 when possible, and also maximizing drive time of the driver in conformance with the CDL rules. It should be noted that the system 100 shown in FIG. 1 is only an example, and systems having more, fewer, or differently located components may be used. For example, some or all of the generation of the route 112 may be performed external to the vehicle 102, such as via an edge computing device or server.

The vehicle 102 may include various types of automobile, crossover utility vehicle (CUV), sport utility vehicle (SUV), truck, recreational vehicle (RV), boat, plane or other mobile machine for transporting people or goods. In many cases, the vehicle 102 may be a battery electric vehicle (BEV) powered by a traction battery and one or more electric motors. As a further possibility, the vehicle 102 may be a hybrid electric vehicle powered by both an engine, a traction battery, and one or more electric motors. Hybrid vehicles 102 may come in various forms, such as a series hybrid electric vehicle, a parallel hybrid electrical vehicle, or a parallel/series hybrid electric vehicle. As the type and configuration of vehicle 102 may vary, the capabilities of the vehicle 102 may correspondingly vary. As some possibilities, vehicles 102 may have different capabilities with respect to passenger capacity, towing ability and capacity, and storage volume. For title, inventory, and other purposes, vehicles 102 may be associated with unique identifiers, such as vehicle identification numbers (VINs), globally unique identifiers (GUIDs), customer or fleet accounts, etc.

The vehicle 102 may further include various computing services to support the communication of the vehicle 102 with infrastructure and/or with the other vehicle 102 themselves. In some examples, the vehicle 102 may perform the communication under the control of the TCU 104. The TCU 104 may include network hardware configured to facilitate communication between the vehicle 102 and other devices of the system 100. For example, the TCU 104 may include or otherwise access a cellular modem configured to facilitate communication with the communications network 106. In some examples, the vehicles 102 further may include wireless transceivers, such as a BLUETOOTH or BLUETOOTH Low Energy (BLE) transceivers, as well as transceivers for communication with the mobile devices (not shown) in addition to or instead of communicating over the communications network 106 directly.

The HMI 108 may be configured to provide information to users of the vehicle 102 as well as to receive input from the users. In an example, the HMI 108 may include one or more display screens and/or touch screens within the cabin of the vehicle 102. In another example, the HMI 108 may include audio functionality, such as one or more microphones to receive voice input and a text-to-speech (TTS) system to provide voice prompts and responses via speakers in the cabin of the vehicle 102. The HMI 108 of the vehicle 102 may be used for tasks such as navigation mapping and routing.

In an example, the HMI 108 may be used for receiving route parameters 110. The route parameters 110 may include information such as such as a current location of the vehicle 102, a destination of the vehicle 102, one or more intermediate waypoints or points of interest that the vehicle 102 wishes to visit, such as stores, pickup locations, drop-off locations, and/or refueling locations. In other examples, the route parameters 110 may be received from other sources, such as from a user's mobile device, from a calendar of the user, etc.

A route 112 refers to a predefined or dynamically generated path that a vehicle 102 follows to travel from a starting location to a destination while considering environmental conditions, road constraints, and traffic rules. The route 112 may be defined based on various factors, including the route parameters 110, as well as road network data, real-time traffic conditions, navigation preferences, and other considerations.

The autonomous driving subsystem 114 may be configured to autonomously drive the vehicle 102 without human intervention. The autonomous driving subsystem 114 may include multiple integrated components, such as sensors, computer processing units, decision-making algorithms, and actuators. The sensors may include LiDAR, radar, cameras, and/or ultrasonic detectors configured to continuously scan the environment surrounding the vehicle 102. This may be performed to detect other vehicles 102, as well as pedestrians, road signs, and obstacles. The collected data may be processed by the computer processing units using techniques such as artificial intelligence (AI) and machine learning models to interpret the driving environment and predict driving operations. The autonomous driving subsystem 114 may accordingly determine driving maneuvers to perform based on real-time conditions, ensuring navigation along the route 112. Based on the determined driving maneuvers, control actuators may be signals to manage and adjust the steering and speed of the vehicle 102 to execute the driving maneuvers smoothly.

In a SAE Level 4 autonomous driving subsystem 114, as defined by the SAE, the vehicle 102 may control all aspects of driving within a defined ODD without human intervention. Unlike lower levels of automation, a SAE Level 4 system does not require a human driver to monitor the operation of the vehicle 102 operation under normal circumstances within the ODD. The autonomous driving subsystem 114 may accordingly handle driving tasks such as navigating intersections, responding to traffic signals, executing lane changes, and adjusting speed in response to traffic flow.

The ODD information 116 refers to the specific conditions and environments in which an autonomous vehicle 102 is designed to operate. The ODD information 116 defines parameters such as geographic boundaries, road types, weather conditions, speed limits, and traffic rules that the autonomous driving subsystem 114 can reliably handle. For instance, a vehicle 102 implementing SAE Level 4 and designed for urban ride-hailing may only operate within a designated metropolitan area with mapped roadways and controlled intersections.

The routing application 118 may be an example of an application executed by the computer processing units of the autonomous driving subsystem 114. The routing application 118 may plan the navigation route 112 based on the route parameters 110 by integrating mapping data, sensor inputs, and predictive algorithms to determine an optimal path that adheres to the ODD information 116 and to the CDL rules for the driver. To do so, the routing application 118 may be configured to perform various aspects of the operation of the autonomous driving subsystem 114 discussed in detail herein.

The routing application 118 may be configured to maintain an activity log 120 of the operation of the vehicle 102. The activity log 120 may include information descriptive of when the autonomous driving subsystem 114 is utilized to drive the vehicle 102 and also when the human driver is instead driving the vehicle 102. Thus, the activity log 120 may define records including durations and conditions of CDL driver driving to satisfy CDL driving log requirements and also exact durations and conditions during SAE Level 4 autonomous driving.

The route queries 122 refer to messages created by the routing application 118 that include information about routes 112 to be taken by the vehicle 102. Each route query 122 may include information about a route 112, such as a current location of the vehicle 102, a destination of the vehicle 102, one or more intermediate waypoints or points of interest along the route 112 that the vehicle 102 wishes to visit, such as stores, pickup locations, drop-off locations, and/or refueling locations.

The ODD server 124 may be an example of a networked computing device that is accessible to the vehicles 102 over the communications network 106. The ODD service 126 may include software configured to be executed by the processor hardware of the ODD server 124. The ODD server 124 may be configured to execute the ODD service 126 to receive the route queries 122 and provide the relevant ODD information 116 in response using the ODD database 128.

The ODD database 128 may store the ODD information 116 for roadways that are traversable by the vehicle 102. The ODD information 116 may be indexed according to roadways, to allow the ODD service 126 to select the ODD information 116 corresponding to the route 112 specified by the route query 122. This selected ODD information 116 may include detailed parameters such as geographic limitations, environmental conditions, roadway characteristics, municipal constraints, and/or infrastructure dependencies. The geographic limitations may indicate defined boundaries within which autonomous operation is permitted, including mapped areas, roads, and restricted zones. The environmental conditions may indicate weather restrictions, such as prohibiting autonomous operation during heavy rain, snow, or extreme temperatures. The roadway characteristics may indicate specifications regarding lane markings, road types (e.g., highways, urban streets, rural roads), speed limits, and traffic control features. The municipal constraints may include traffic rules, jurisdiction-specific rules, and CDL-related limitations that may affect the engagement of the autonomous driving subsystem 114. The infrastructure dependencies may include data regarding required infrastructure support, such as vehicle-to-infrastructure (V2I) connectivity, high-definition map availability, or required sensor visibility.

The ODD service 126 may be further configured to manage updates to the ODD database 128. For example, the ODD service 126 may be configured to update the ODD database 128 to reflect changes in road conditions, rules, and real-time data inputs. In an example, the ODD service 126 may receive external data feeds from government transportation agencies or road network providers, and/or fleet management systems. It should be noted that, while the ODD server 124, ODD service 126, and ODD database 128 are illustrated as remote from the vehicle 102, in some implementations the functionality of one or more of the ODD server 124, ODD service 126, and ODD database 128 may be implemented partially or entirely onboard the vehicle 102.

The weather server 130 may be another example of a networked computing device that is accessible to the vehicles 102 over the communications network 106. The weather service 132 may include software configured to be executed by the processor hardware of the weather server 130. The weather server 130 may be configured to execute the weather service 132 to receive the route queries 122 and provide the relevant weather information 134 in response using the weather database 136.

The weather information 134 may include information about current and predicted weather conditions. For example, the weather information 134 may include parameters such as temperature, precipitation levels, wind speed, humidity, fog density, and road surface conditions (e.g., icy, wet, or dry).

The weather database 136 may include up-to-date weather data obtained from various sources, such as meteorological agencies, satellite observations, roadway weather sensors, and vehicle-based weather detection systems. The weather database 136 may store historical weather patterns and predictive models for use in generating real-time weather forecasts relevant to a route query 122. This information may be indexed by geographic region, time, and roadway-specific data to provide tailored weather insights for determination against the ODD information 116 for allowed operation of the autonomous driving subsystem 114.

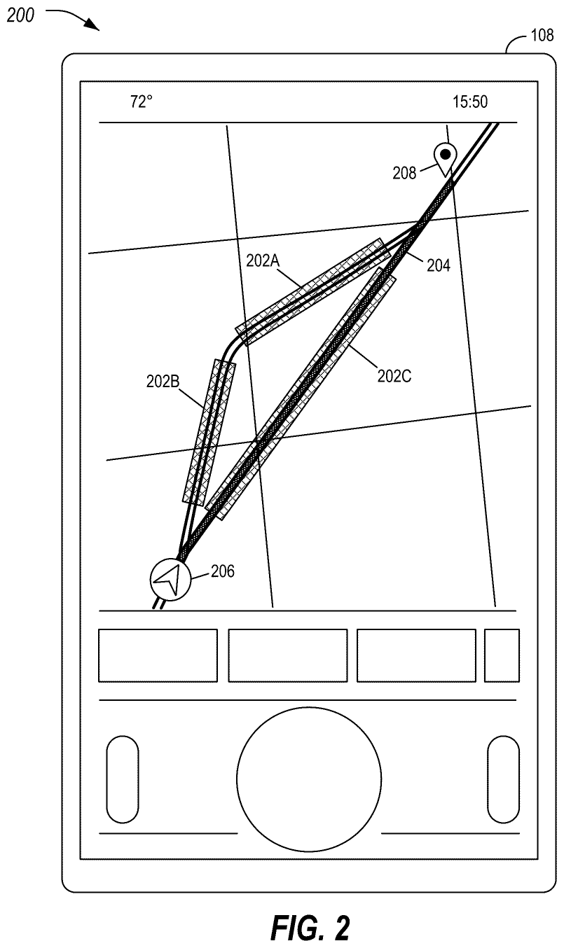

FIG. 2 illustrates an example navigation user interface 200 of the vehicle HMI 108 illustrating three example ODD zones 202A, 202B, 202C (collectively ODD zones 202) in which the autonomous driving subsystem 114 may be configured to autonomously drive the vehicle 102 without human intervention. The navigation user interface 200 may be used to allow the user to view the locations of the ODD zones 202, the route 112 as shown by a route path 204, as well as the progress of an avatar 206 of the vehicle 102 to the destination of the route 112, here shown as pin location 208. In an example, the navigation user interface 200 may be provided by the vehicle HMI 108 to a display within the cabin of the vehicle 102.

As illustrated, the ODD zones 202 visually indicate road segments where, based on the ODD information 116, the autonomous driving subsystem 114 is able to drive the vehicle 102 without human intervention. The other positions of the roadway would still be required to be driven by a human operator. For instance, the first ODD zone 202A and the second ODD zone 202B are provided along a Western path between the vehicle 102 and the destination. Similarly, the third ODD zone 202C is provided along a shorter Eastern path to the destination. Notably, while traversing the ODD zones 202, the autonomous driving subsystem 114 may indicate in the activity log 120 that the vehicle 102 was driving, such that these hours do not count towards the human's maximums per the CDL rules. On the other hand, when the human operator is driving the vehicle 102, the activity log 120 will note for that time the drive time that is incurred.

Based on the distances to travel and the ODD zones 202, the autonomous driving subsystem 114 determines the route 112, which is shown as the route path 204 from the avatar 206 to the pin location 208 along the Eastern choice. This path is not only shortest, but it also provides a significant amount of SAE Level 4 driving experience under the control of the autonomous driving subsystem 114. In this example, not only is the distance shorter, but also the human drive time is also shorter than the Western choice.

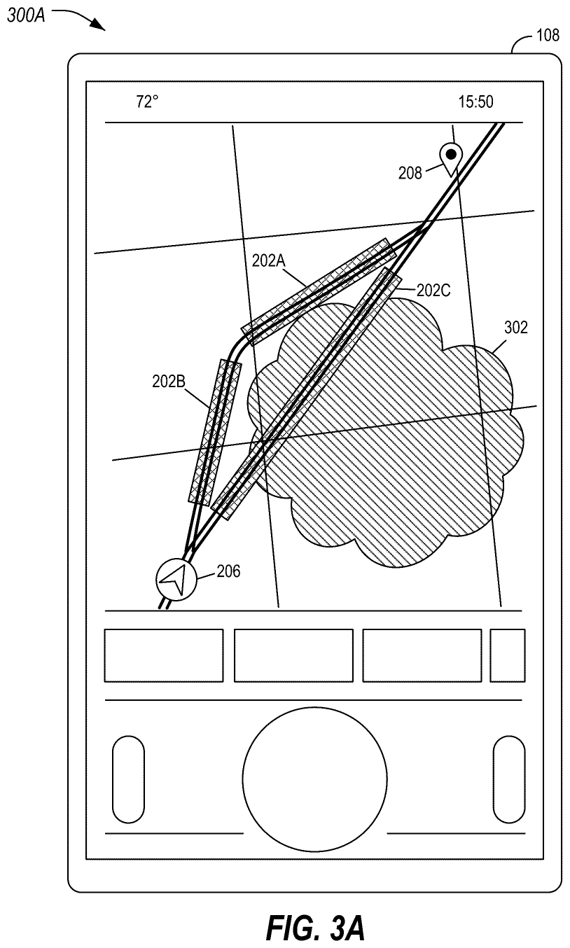

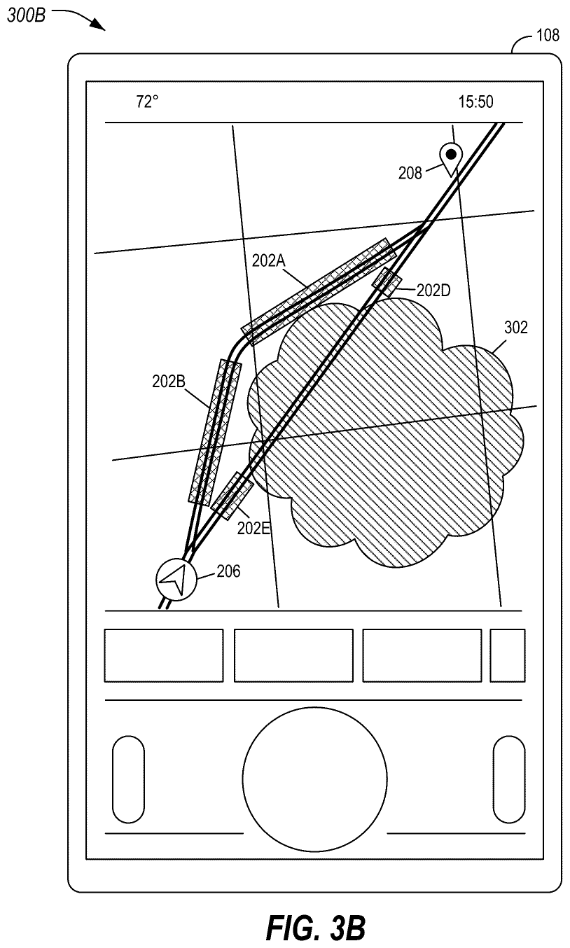

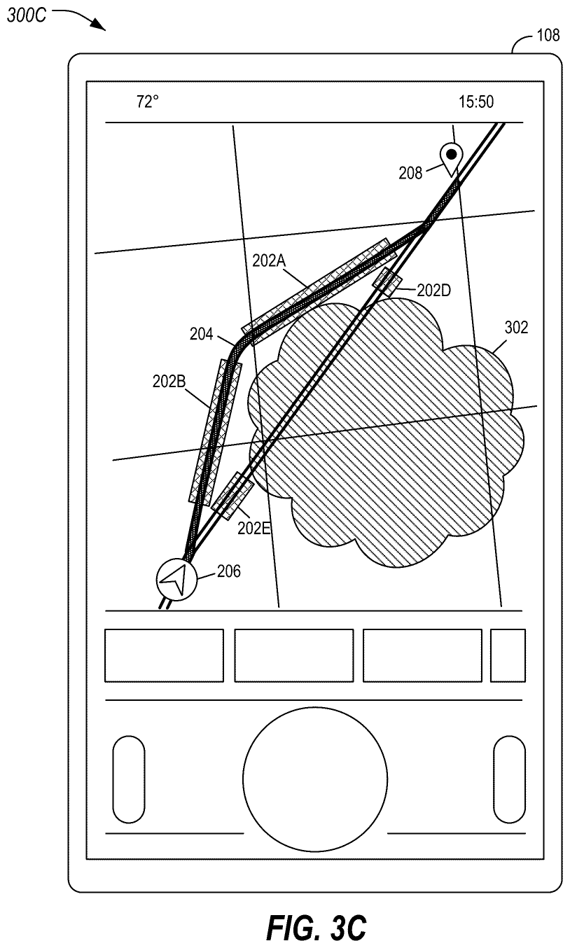

FIG. 3A illustrates an example navigation user interface 300A of the vehicle HMI 108 illustrating the ODD zones 202 and, additionally, weather zones 302 gleaned from the weather information 134. For example, the weather zone 302 as shown may indicate a region of fog over a portion of the roadway.

In this example, the fog may be incompatible with the ODD information 116 corresponding to the ODD zone 202C. In this case, the autonomous driving subsystem 114 may no longer be enabled to operation in SAE Level 4 along the portion of the ODD zone 202C that is within the weather zone 302.

FIG. 3B illustrates an example navigation user interface 300B of the vehicle HMI 108 illustrating revised ODD zones 202 based on the weather information 134. Here, it can be seen that the ODD zone 202C is now updated into two smaller ODD zones 202D and 202E, which are the portions of the ODD zone 202C that are not also within the weather zone 302.

FIG. 3C illustrates an example navigation user interface 300C of the vehicle HMI 108 illustrating a revised route path 204 based on the revised ODD zones 202. In this example, as compared to as shown in FIG. 2, the autonomous driving subsystem 114 determines the route 112 to take the Western choice instead, which is not the shortest route path 204 from the avatar 206 to the pin location 208. This path is longer, but it provides overall less CDL driver time because the SAE Level 4 driving is still allowable through ODD zone 202A and ODD zone 202B. Thus, while the distance is not shorter, but also the human drive time is shorter.

It should be noted that this is only an example, and various weightings of CDL driver versus autonomous driving subsystem 114 driving may be used. Moreover, other factors may be considered in combination with reducing CDL driver time, such as optimizing to reduce overall mileage, optimizing to minimize fuel and/or battery usage, optimizing to reduce overall time, etc.

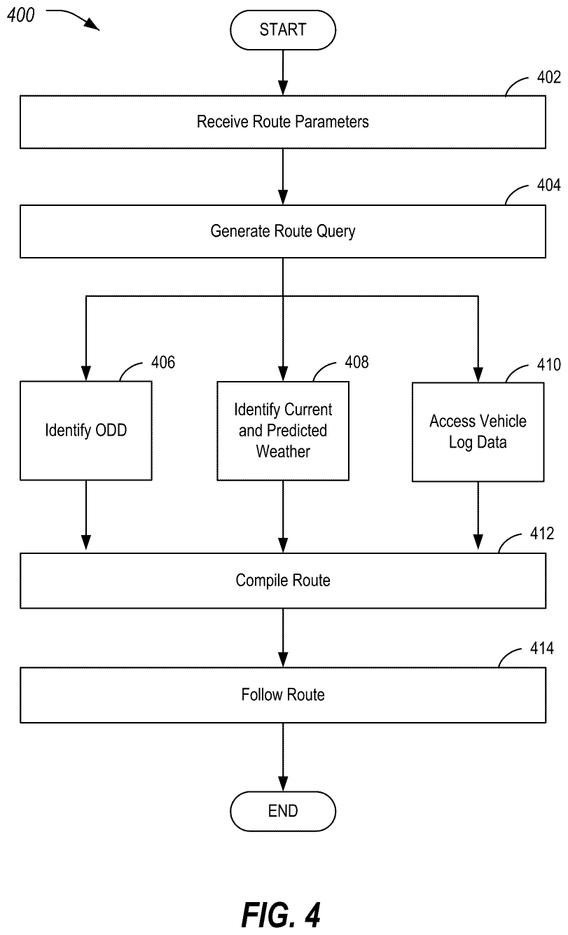

FIG. 4 illustrates an example process 400 for determining and traversing a route 112 by the vehicle 102. In an example, the process 400 may be performed by the autonomous driving subsystem 114 of the vehicle 102 in the context of the system 100.

At operation 402, the autonomous driving subsystem 114 receives route parameters 110. In an example, the route parameters 110 may be derived from user inputs entered via the HMI 108 (e.g., using touch screen input or voice command input) or from external sources such as fleet management systems, scheduling applications, or mobile devices. The route parameters 110 may include information such as the current location of the vehicle 102, the intended destination or drop-off location, and possible intermediate waypoints or points of interest. The route parameters 110 may also include driver preferences, such as whether to not traverse toll roads or use only certain highways, as well as any scheduling constraints. In some examples, these parameters may indicate driver-related constraints, such as remaining driving hours under CDL rules.

At operation 404, the autonomous driving subsystem 114 generates a route query 122 based on the route parameters 110. In an example, the autonomous driving subsystem 114 compiles the route parameter 110 data to be shared with external services. For instance, the generated route query 122 may package the starting location, waypoints, and destination in a format recognized by the ODD service 126 and the weather service 132. The route query 122 may also include additional details indicating approximate arrival times and any special routing needs (e.g., mandatory rest intervals), enabling those external services to return the most relevant ODD information 116 and weather information 134.

At operation 406, the autonomous driving subsystem 114 identifies ODD information 116. In an example, the autonomous driving subsystem 114 may receive the ODD information 116 from the ODD server 124 including definitions of permitted roadways and operational constraints for SAE Level 4 autonomy.

At operation 408, the autonomous driving subsystem 114 identifies weather information 134 including current and predicted weather. This information may be provided by the weather server 130 in response to the route query 122 and may include data such as precipitation levels, fog density, temperature, wind speed, and other relevant conditions along the travel path. Additionally, or alternatively, the current weather conditions may be detected by sensors of the vehicle 102.

At operation 410, the autonomous driving subsystem 114 accesses the activity log 120 of the vehicle 102. For instance, the autonomous driving subsystem 114 may retrieve CDL-related data and prior recorded hours of service for the human driver. The activity log 120 may indicate whether the driver has been actively operating the vehicle 102, resting, or off-duty, as well as the periods in which SAE Level 4 autonomy was engaged. Because CDL drivers are subject to drive-time rules, the autonomous driving subsystem 114 checks remaining allowable drive hours to ensure that future driving segments agree with rules such as maximum on-duty limits or required rest breaks.

At operation 412, the autonomous driving subsystem 114 compiles the route 112 accounting for the ODD information 116, the weather information 134, and the CDL drive time as indicated in the activity log 120. In an example, the autonomous driving subsystem 114 evaluates the different route 112 options to determine which path optimizes conformance and efficiency. The autonomous driving subsystem 114 may utilize various routing algorithm, such as Dijkstra's algorithm, A* algorithm, dynamic programming, or machine learning-based optimization to find the most suitable route 112 from the origin location of the vehicle 102 to the destination via the waypoints.

In some examples, the autonomous driving subsystem 114 may choose a path that maximizes autonomous driving segments and minimizes CDL driver time so that the driver can rest during those intervals, thereby extending overall drive time under CDL constraints. For instance, the route 112 may minimize

$${T}_{driver} = {\sum }_{i} {t}_{human , i} ,$$

where t_{human, i} is the duration of the human-driven segments along the route 112.

In another example, the autonomous driving subsystem 114 may choose a path that minimizes total miles. For instance, the route 112 may minimize

$${D}_{total} = {\sum }_{j} {d}_{segment , j} ,$$

where d_{segment, j} is the length of the segments along the route 112, regardless of whether the vehicle 102 is driven by the autonomous driving subsystem 114 or the CDL driver.

In yet another example, the autonomous driving subsystem 114 may choose a path that minimizes energy usage. For instance, the route 112 may minimize

$${E}_{total} = {\sum }_{k} {e}_{segment , k} ,$$

where e_{segment, k} is the expected or historical average fuel usage for traversing the segments along the route 112.

In still another example, the autonomous driving subsystem 114 may choose a path as a weighted objective function of multiple factors. In such an example, each of the factors may be assigned weights based on priorities set by the fleet management system or driver preference. For example, if the primary goal is to maximize CDL driver rest periods, more weight can be given to autonomous segments. Conversely, if reducing operational expenses is the primary goal, minimizing fuel usage may be more heavily weighted. The overall routing decision may be represented as a weighted objective function, such as to minimize W₁·T_{driver}+W₂·Dₜₒₜₐₗ+W₃·Eₜₒₜₐₗ, where W₁, W₂, W₃ are relative weighting factors assigned to each optimization goal.

Moreover, by correlating the weather information 134 with the ODD information 116, the autonomous driving subsystem 114 may determine whether conditions remain within acceptable limits for SAE Level 4 autonomy or whether certain regions along the route 112 will instead be driven by a human operator.

At operation 414, the autonomous driving subsystem 114 following the determined route 112 using the SAE Level 4 autonomous driving subsystem 114 when allowed and otherwise using the human driver. Should the route 112 take the vehicle 102 outside the permissible ODD boundaries or into unfavorable weather, the autonomous driving subsystem 114 transitions control to the human driver. During the journey, the autonomous driving subsystem 114 continues to record driving details in the activity log 120, including the intervals of autonomous vs. human control, and to alert the driver of impending rest or break requirements. After operation 414, the process 400 ends.

By sharing driving responsibilities between the vehicle's SAE Level 4 subsystem and the commercial driver, the overall travel time may be extended while remaining confirming with CDL rules and ODD definitions. This arrangement can reduce driver fatigue, help ensure proper rest breaks, and maximize route 112 efficiency under the constraints described herein.

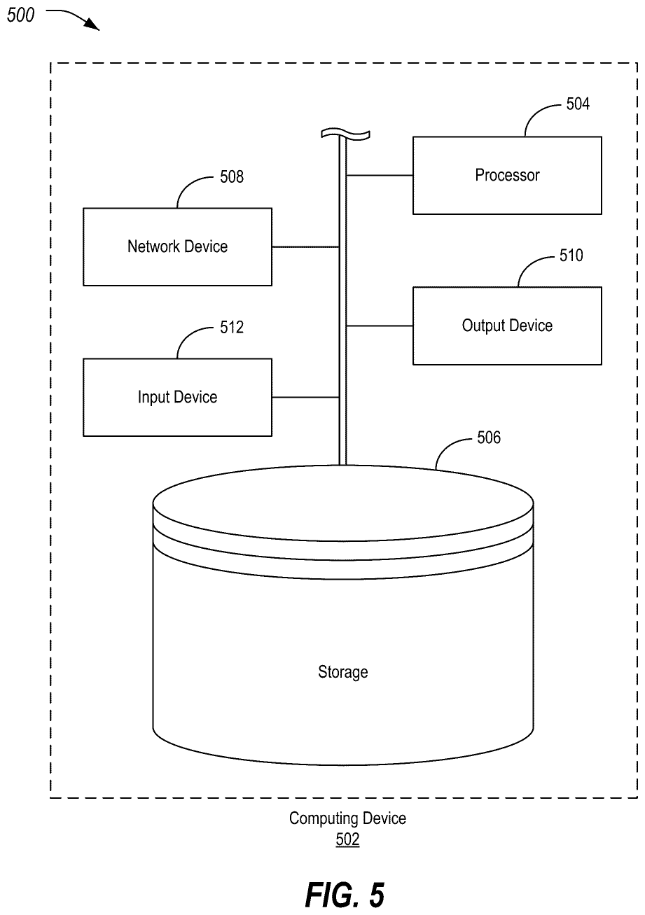

FIG. 5 illustrates an example computing device supporting the determining and traversing a route 112 by the vehicle 102. Referring to FIG. 5, and with reference to FIGS. 1-5, the TCU 104, communications network 106, HMI 108, autonomous driving subsystem 114, ODD server 124, weather server 130, etc., may be examples of such computing devices 502. Computing devices 502 generally include computer-executable instructions, where the instructions may be executable by one or more computing devices 502. Computer-executable instructions may be compiled or interpreted from computer programs created using a variety of programming languages and/or technologies, including, without limitation, and either alone or in combination, Java™, C, C++, C#, Visual Basic, JavaScript, Python, JavaScript, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data, such as the route parameters 110, route 112, ODD information 116, routing application 118, activity log 120, route queries 122, weather information 134, etc., may be stored and transmitted using a variety of computer-readable media.

As shown, the computing device 502 may include a processor 504 that is operatively connected to a storage 506, a network device 508, an output device 510, and an input device 512. It should be noted that this is merely an example, and computing devices 502 with more, fewer, or different components may be used.

The processor 504 may include one or more integrated circuits that implement the functionality of a central processing unit (CPU) and/or graphics processing unit (GPU). In some examples, the processors 504 are a system on a chip (SoC) that integrates the functionality of the CPU and GPU. The SoC may optionally include other components such as, for example, the storage 506 and the network device 508 into a single integrated device. In other examples, the CPU and GPU are connected to each other via a peripheral connection device such as Peripheral Component Interconnect (PCI) express or another suitable peripheral data connection. In one example, the CPU is a commercially available central processing device that implements an instruction set such as one of the x86, ARM, Power, or Microprocessor without Interlocked Pipeline Stages (MIPS) instruction set families.

Regardless of the specifics, during operation the processor 504 executes stored program instructions that are retrieved from the storage 506. The stored program instructions, accordingly, include software that controls the operation of the processors 504 to perform the operations described herein. The storage 506 may include both non-volatile memory and volatile memory devices. The non-volatile memory includes solid-state memories, such as Not AND (NAND) flash memory, magnetic and optical storage media, or any other suitable data storage device that retains data when the system is deactivated or loses electrical power. The volatile memory includes static and dynamic random access memory (RAM) that stores program instructions and data during operation of the system 100.

The GPU may include hardware and software for display of at least two-dimensional (2D) and optionally three-dimensional (3D) graphics to the output device 510. The output device 510 may include a graphical or visual display device, such as an electronic display screen, projector, printer, or any other suitable device that reproduces a graphical display. As another example, the output device 510 may include an audio device, such as a loudspeaker or headphone. As yet a further example, the output device 510 may include a tactile device, such as a mechanically raiseable device that may, in an example, be configured to display braille or another physical output that may be touched to provide information to a user.

The input device 512 may include any of various devices that enable the computing device 502 to receive control input from users. Examples of suitable input devices 512 that receive human interface inputs may include keyboards, mice, trackballs, touchscreens, microphones, graphics tablets, and the like.

The network devices 508 may each include any of various devices that enable the described components to send and/or receive data from external devices over networks. Examples of suitable network devices 508 include an Ethernet interface, a Wi-Fi transceiver, a cellular transceiver, or a BLUETOOTH or BLE transceiver, or other network adapter or peripheral interconnection device that receives data from another computer or external data storage device, which can be useful for receiving large sets of data in an efficient manner.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A method of operating an autonomous vehicle in coordination with a commercial driver license (CDL) driver, the method comprising:
receiving route parameters including a destination and a current vehicle location;
sending a route query based on the route parameters to an operational design domain (ODD) server to receive ODD information defining autonomous operation conditions and boundaries;
sending the route query to a weather server to receive current and predicted weather information;
determining, based on the received ODD information, the weather information, and an activity log documenting allowable commercial driver operation time under commercial driver license (CDL) rules, a route optimized to maximize autonomous driving segments and manage commercial driver rest periods; and
operating the vehicle along the route using an autonomous driving subsystem within ODD zones conformant with the ODD information, and under CDL driver control outside the ODD zones.

2. The method of claim 1, further comprising updating the activity log by automatically recording durations of operation by the autonomous driving subsystem and by the commercial driver.

3. The method of claim 1, wherein determining the route includes selecting route segments to minimize total driving time of the commercial driver outside the ODD zones.

4. The method of claim 1, wherein the activity log includes automated recording of timestamps indicating transitions between commercial driver and the autonomous driving subsystem.

5. The method of claim 1, wherein the route parameters further include one or more intermediate waypoints, the intermediate waypoints including refueling locations, pick up locations, and/or drop-off locations.

6. The method of claim 1, wherein the autonomous driving subsystem operates, without human intervention, in Society of Automotive Engineer (SAE) Level 4 autonomous operation.

7. The method of claim 1, further comprising excluding autonomous use of portions of ODD zones overlapping weather zones indicated by the weather information as being unavailable based on the ODD information.

8. The method of claim 1, further comprising determining the route as a using a weighted objective function to minimize a weighting of commercial driver time, total driving distance, and energy usage.

9. An autonomous vehicle for operating autonomously and in coordination with a commercial driver, the vehicle comprising:
an autonomous driving subsystem;
a storage maintaining an activity log documenting allowable commercial driver operation time under CDL rules; and
one or more computing devices, configured to:
receive route parameters including a destination and a current vehicle location,
send a route query based on the route parameters to an ODD server to receive ODD information defining autonomous operation conditions and boundaries,
send the route query to a weather server to receive current and predicted weather information,
determine, based on the received ODD information, the weather information, and the activity log, a route optimized to maximize autonomous driving segments and manage commercial driver rest periods, and
operate the vehicle along the route using the autonomous driving subsystem within ODD zones conformant with the ODD information, and under CDL driver control outside the ODD zones.

10. The vehicle of claim 9, wherein the one or more computing devices are further configured to one or more of:
update the activity log by automatically recording durations of operation by the autonomous driving subsystem and by the commercial driver, or
wherein the activity log includes automated recording of timestamps indicating transitions between commercial driver and the autonomous driving subsystem.

11. The vehicle of claim 9, wherein determining the route includes selecting route segments to minimize total driving time of the commercial driver outside the ODD zones.

12. The vehicle of claim 9, wherein the route parameters further include one or more intermediate waypoints, the intermediate waypoints including refueling locations, pick up locations, and/or drop-off locations.

13. The vehicle of claim 9, wherein the autonomous driving subsystem operates, without human intervention, in SAE Level 4 autonomous operation.

14. The vehicle of claim 9, wherein the one or more computing devices are further configured to exclude autonomous use of portions of ODD zones overlapping weather zones indicated by the weather information as being unavailable based on the ODD information.

15. The vehicle of claim 9, wherein the one or more computing devices are further configured to determine the route as a using a weighted objective function to minimize a weighting of commercial driver time, total driving distance, and energy usage.

16. A non-transitory computer-readable medium comprising instructions for operating an autonomous vehicle both autonomously and in coordination with a commercial driver, that when executed by one or more computing devices cause the one or more computing devices to perform operations including to:
receive route parameters including a destination and a current vehicle location;
send a route query based on the route parameters to an ODD server to receive ODD information defining autonomous operation conditions and boundaries;
send the route query to a weather server to receive current and predicted weather information;
determine, based on the received ODD information, the weather information, and an activity log documenting allowable commercial driver operation time under CDL rules, a route optimized to maximize autonomous driving segments and manage commercial driver rest periods; and
operate the vehicle along the route using an autonomous driving subsystem of the vehicle within ODD zones conformant with the ODD information, and under CDL driver control outside the ODD zones.

17. The non-transitory computer-readable medium of claim 16, further comprising instructions that, when executed by the one or more computing devices, cause the one or more computing devices to perform operations including to update the activity log by automatically recording durations of operation by the autonomous driving subsystem and by the commercial driver, wherein the activity log includes automated recording of timestamps indicating transitions between commercial driver and the autonomous driving subsystem.

18. The non-transitory computer-readable medium of claim 16, wherein determining the route includes selecting route segments to minimize total driving time of the commercial driver outside the ODD zones.

19. The non-transitory computer-readable medium of claim 16, further comprising instructions that, when executed by the one or more computing devices, cause the one or more computing devices to perform operations including to exclude autonomous use of portions of ODD zones overlapping weather zones indicated by the weather information as being unavailable based on the ODD information.

20. The non-transitory computer-readable medium of claim 16, further comprising instructions that, when executed by the one or more computing devices, cause the one or more computing devices to perform operations including to determine the route as a using a weighted objective function to minimize a weighting of commercial driver time, total driving distance, and energy usage.
